(19) United States
(12) Patent Application Publication
(10) Pub. No.: US 2024/0303245 A1
(43) Pub. Date: Sep. 12, 2024

(54) COMPUTERIZED METHODS FOR ENABLING USERS TO GRADUALLY INTERACT WITH A DATABASE ASSOCIATING ITEMS WITH FEATURES

(71) Applicant: ATTRAQT LIMITED, London (GB)

(72) Inventors: Stanislav Viktorovich FATEEV, Obl. Moskovskaya (RU); Taras LUKAVYI, Lviv (UA); Antonius Jozef VOLLEBREGT, Zürich (CH); Jukkapekka HEKANAHO, Zürich (CH); Ken WÄCKERLI, Spreitenbach (CH)

(73) Assignee: ATTRAQT LIMITED, London (GB)

(21) Appl. No.: 18/276,368

(22) PCT Filed: Feb. 9, 2021
(86) PCT No.: PCT/EP2021/053104

§ 371 Date: Aug. 8, 2023

(51) Int. Cl. G06F 16/2457; G06F 16/248

(52) U.S. Cl. CPC G06F 16/24578; G06F 16/248

(57) ABSTRACT

The invention is notably directed to a method of enabling a user (2) to interact with a database associating items with features. The method first comprises accessing the database to obtain an association of the items and the features as a static dataset. Both the static dataset and initial values of a dynamic dataset are loaded in the main memory of a computerized system. The dynamic dataset is meant to capture essential outcomes of the user interaction during her/his search journey. Next, several computational cycles are performed at the computerized system. Such cycles are preferably performed without querying the database. Each of the cycles comprises the following steps. First, upon receiving (S31) an input of the user in respect of one or more of the features, the dynamic dataset is updated (S32) according to the received input. As a result, updated dynamic dataset values are stored in the main memory. The updated dynamic dataset values represent current valuations of the features of the items. Second, the items are ordered (S33) according to the updated dynamic dataset values. This is achieved by performing an operation involving two operands, in-memory. The operands are accessed from the main memory; they are obtained from the static dataset and the updated dynamic dataset, respectively. The operation is preferably performed as a matrix-vector product, where the matrix is obtained as a one-hot encoded matrix. Third, the method instructs (S354, S368), based on the updated dynamic dataset, to prompt the user to provide a further input in respect of one or more of the features associated with at least one of the items. Moreover, at least one of the cycles further comprises instructing (S37) to display an array of at least a subset of highest-ranked items of the ordered items, together with features associated with each of the displayed items, by virtue of the association obtained earlier. The invention is further directed to related computerized systems and computer program products.

### CLAIM FOR PRIORITY

The present application is a national stage filing under 35 U.S.C 371 of PCT application number PCT/EP2021/053104, having an international filing date of Feb. 9, 2021, the disclosure of which is hereby incorporated by reference in its entirety.

### BACKGROUND

The invention relates in general to the field of computerized techniques for enabling users to interact with databases, e.g., to search for items within such databases. It notably concerns computer-implemented methods, computerized systems, and computer program products.

In particular, the invention is directed to methods allowing a user to interact with a database associating items with features, e.g., thanks to software components that asynchronously execute at a user device but are partly controlled by a remote core computation system, whereby items are repeatedly ordered based on inputs gradually received from a user. This is achieved thanks to in-memory operations (i.e., without querying the database) involving, on the one hand, a dynamically updated operand that captures stepwise interactions of the user with the database, and, on the other hand, a static operand, which is preferably obtained as a one-hot encoded matrix.

Most product search platforms (such as e-commerce and marketplace platforms) allow users to interact with a database through user interfaces involving filters. Such filters usually require the user to select binary (e.g., include or exclude) feature requirements. Typically, these requirements are subsequently fed into an SQL statement on a database to retrieve matching items. The filter-based approach has remained largely unchanged since the early days of the internet. This search mechanism is unnecessarily restrictive; it often leads to user confusion and frustration. Besides, filter-based searches typically require numerous interactions with databases (i.e., implying multiple database queries), which use a lot of network bandwidth and are time inefficient. Based on these observations, the present inventors set out to elaborate a new paradigm for searching for items online.

### SUMMARY

According to a first aspect, the present invention is embodied as a method of enabling a user to interact with a database associating items with features. The method first comprises accessing the database to obtain an association of the items and the features as a static dataset. Both the static dataset and initial values of a dynamic dataset are loaded in the main memory of a computerized system. The dynamic dataset is meant to capture essential characteristics of the user interactions during her/his search journey. Next, several computational cycles are performed at the computerized system. Such cycles are preferably performed without querying the database. Each of the cycles comprises the three following steps. First, upon receiving an input of the user in respect of one or more of the features, the dynamic dataset is updated according to the received input. As a result, updated dynamic dataset values are stored in the main memory. The updated dynamic dataset values represent current valuations of the features of the items. Second, the items are ordered according to the updated dynamic dataset values. This is achieved by performing, in-memory, an operation involving two operands. The operands are accessed from the main memory; they are obtained from the static dataset and the updated dynamic dataset, respectively. Third, the method instructs, based on the updated dynamic dataset, to prompt the user to provide a further input in respect of one or more of the features associated with at least one of the items. Moreover, at least one of the cycles further comprises instructing to display an array of at least a subset of highest-ranked items of the ordered items, together with features associated with each of the displayed items, by virtue of the association obtained earlier.

According to the proposed approach, each user indirectly interacts with the database thanks to the computational cycles performed in-memory. I.e., ordering the items does not require querying the database. This is advantageous given the typically large footprints of contemporary databases, especially databases of items such as consumer goods. Rather, all the core computational steps are performed in-memory, thanks to processing means interacting with the main memory (i.e., the primary storage of the core computational system) only, without it being needed to access the database (or a secondary storage, for that matter). This allows an improved execution speed and requires little data communication bandwidth. The present method also has benefits in terms of user experience. According to the proposed approach, the dynamic dataset values are gradually updated, which allows a progressive, personalized search (the dynamic dataset values are user-specific).

In preferred embodiments, at the step of ordering the items, a first one of the two operands is obtained as a matrix from the static dataset, prior to performing the several computational cycles, while a second one of the two operands is, at each of the computational cycles, obtained from the dynamic dataset as a first vector that is dimensioned consistently with the matrix. The operation is performed, at each cycle, as a matrix-vector product, to obtain a second vector, which represents the valuations. Accordingly, the items are ordered according to the second vector. Relying on matrix-vector product allows an easy and quick operation, which has a low computational cost and can fairly easily be performed in-memory, especially as the matrix can be loaded prior to perform the computational cycles.

Preferably, the first one of the two operands is obtained as a one-encoded matrix, i.e., a one-hot or a one-cold encoded matrix, whereby each matrix element of the matrix is a binary value that may have one of two possible values. This allows a simple representation of the matrix, which can be substantially compressed, and the matrix-vector products can be very efficiently performed in-memory, based on a compressed representation of the matrix. Meanwhile, the vector elements of the first vector are preferably obtained as nonbinary values, i.e., values that are defined according to a nonbinary numeral system. This allows the values associated with items in the second vector to have a staircase structure, which, eventually, results in a more meaningful ordering of the items to be obtained (from the user point of view) than with filter-based searches, where no further distinction can be made amongst the items retrieved.

The one-encoding process should be understood in a broad sense. I.e., the process does, preferably, not impose legal combinations of binary values on columns and rows of the matrix. That is, the matrix is preferably obtained as an N×M matrix, having N rows and M columns, where each of the items is associated with a respective one of the N rows, by encoding the features into the M columns according to the obtained associations. For instance, the matrix may be obtained by separately encoding the features to obtain respective matrices of N rows each and then concatenating the respective matrices along their rows. This amounts to mapping the features to feature values in a feature space, so as to associate each feature with one or more columns. This process may potentially give rise to several high bit values on one or more of the columns (as well as on any row, by construction). In that sense, illegal combinations of binary values are tolerated. The resulting matrix contains only N rows, onto which the items are mapped. This makes it simple to handle; the scalar product of a row vector and the dynamic vector directly tells about the score of the corresponding item. Now, in practice, not all the rows may necessarily be needed to perform the operation. I.e., only a subset of the N rows may be needed at a time. Row compression of the matrix can advantageously be used in that case, such that the size of the matrix loaded in the main memory remains tractable. Plus, the resulting structure can easily be updated: any new feature can be appended by concatenating the correspondingly extracted matrix.

Preferably, the association of the items and the features is already obtained as a compressed representation of the matrix, wherein, preferably, rows of the columns are compressed. That is, the static dataset is already a compressed representation of the matrix. This compressed representation is loaded in the main memory, prior to performing the several computational cycles. In that case, the first operand is identical to the static dataset. However, the first operand is accessed from the main memory, for the purpose of performing the operation. So, the operation is performed based on the compressed representation of the matrix, as accessed from the main memory and, this, at each computational cycle.

In preferred embodiments, the computerized system is configured to provide a graphical user interface (GUI), for the user to interact with. The method further comprises running software components at the computerized system and, this, at each of the computational cycles. The software components are asynchronously run as atomic operations to perform respective processes, which control, at least partly, the GUI. Such processes respectively allow the input of the user to be received and the user to be prompted to provide said further input and, this, at each cycle. Relying on asynchronous, atomic operations allows a simple orchestration of the various concurrent processes involved.

Preferably, the computerized system includes a user device of the user, a frontend system, and a core system, the latter including the main memory. The dynamic dataset is updated by the core system and the items are ordered by the core system. The software components are delivered by the frontend system to the user device. The software components are run at the user device, so as to allow the user to interact with said GUI. Note, however, that the GUI may typically include additional GUI components, i.e., in addition to such software components. The core system is in data communication with the user device, such that the software components run at the user device may interact with the core system to accordingly perform said respective processes.

This way, the user interactions governed by the software components can be directly forwarded to and updated from the core system. Meanwhile, the functionalities of such software components can be separated from the functionality of other frontend components. In particular, this makes it possible to easily reconcile constraints arising from a customer platform (which includes the frontend system) and the core computations. For example, this architecture allows the customer platform to implement its own GUI features, while retaining core functionalities of the software components (as driven from/impacting the core system). Moreover, this approach offers much flexibility in operationalizing the present methods on existing customer platforms. Using software components as described above allows a “plug-in” approach that is fast and easy to implement and makes it possible to uniformize implementations of the present methods with various customer platforms. So, the above architecture can easily be augmented; the core may similarly interact with multiple customer platforms. In less preferred variants, interactions between the software components and the core system may be mediated through the frontend system.

The computerized system may further include a backend system (e.g., forming part of the customer platform), as in embodiments. The backend system may notably be involved at the step of instructing to display the array. This step may comprise sending a list of the ordered items from the core system to the backend system, so as for the backend system to retrieve data associated with the highest-ranked items and send the retrieved data to the frontend system, and the frontend system to build a web page script including the retrieved data and the software components and deliver the web page script to the user device for execution thereat. This makes it possible to seamlessly integrate the present approach with customer platforms, which, e.g., require the backend to build the new item array and send it to frontend to display to the user. However, since the software components are embedded in the web page script, the processes evoked earlier (which enable the prompts and the user inputs) can be maintained. Such embodiments require the backend system to occasionally access the database to build a portion of the array to be displayed. However, such operations are performed by the backend system and not the core system; the additional data exchanges between the core system and the backend system (to communicate the list) consume little data communication bandwidth, while data transmission within the customer platform can be locally optimized, at little cost for the customer and the environment.

In embodiments, the core system partly controls the software components by asynchronously updating the software components, in accordance with the updated values of the dynamic dataset. This makes it easier to orchestrate updates to the various GUI elements. All the more, this results in a better user experience, since the GUI elements are updated on the fly, without imposing any synchronization delay.

Preferably, the software components comprise wrappers that wrap instructions from the core system. Running the software components notably causes such instructions to prompt the user to provide said further input. The wrappers act as an insulation layer, which insulates the frontend system from the core, thereby ensuring a safe “plug-in” implementation of the software components, which can remain essentially independent of the frontend technology.

In preferred embodiments, the computerized system further includes a platform, which includes the frontend system and a backend system, as noted above. In that case, accessing the database may comprise communicating data from the backend system to the core system for the latter to ingest the communicated data. The core system then performs featurization to obtain the static dataset. Featurization is performed by: identifying items associated with first features (i.e., features already identified as such within the communicated data); discovering second features (i.e., not identified as such in the communicated data) using semantic and syntactic text analysis; and tagging the items with respective features, these including the first features identified and the second features discovered. Thus, the obtained association eventually associates the items with features that includes both the first features and the second features. In addition, the core system locates, in the communicated data, natural language descriptions of the items that contain said features and activates the features in the located descriptions to subsequently allow a user to interact with such features via the GUI. Accordingly, a wide range of features may advantageously be discovered and integrated for the user to interact with, these including features not identified as such in the initial database.

In embodiments, the core system may implement an adaptive featurization scheme. To that aim, additional steps can be performed upon receiving a request of the user (during any of the computational cycles) that the core system cannot relate to any of the features identified so far. Such a request may for instance be formed by the user interacting with one of the software components. First, the database is accessed again, to search for items presenting an unlabelled feature matching this request. The already identified features are updated to include the hitherto unlabelled feature. The static dataset is accordingly updated, for it to reflect an updated association of the items and the updated features (i.e., including the added feature). E.g., one or more corresponding new columns are entered in the one-hot encoded matrix. Next, the updated static dataset is loaded in the main memory and the dynamic dataset is modified to take the new features into account. Then, the normal process is resumed, whereby the items can be ordered according to the modified dynamic dataset by performing an operation as described above, although this operation is now based on updated operands, respectively obtained from the updated static dataset and the modified dynamic dataset. Although this adaptive featurization involves further database accesses, these are infrequent in practice and consist of simple searches for single text strings. Accordingly, they imply only a small overhead.

In embodiments, the method further comprises, prior to instructing to display the array, selecting, based on the updated dynamic dataset, at least a subset of the features associated with the highest-ranked items as per the obtained association, for the selected features to be subsequently displayed as part of the array.

Preferably, the selected features are instructed to be displayed as user-selectable, in-place features of the highest-ranked items, in association with respective items of said highest-ranked items, within said array. In addition, the user is prompted to provide said further input in respect of any one of the selected features. Such in-place features provide an intelligent feedback trigger and can conveniently be interacted with, in-place, as the user does not have to go back to the filter-based menu.

More preferably, the user input received at one of the cycles comprises a rating of a given feature. The rating is formulated thanks to a GUI component activated in response to the user having selected one of the user-selectable, in-place features.

In preferred embodiments, the method further comprises identifying, based on the updated dynamic dataset values, a given one of the features that may benefit from clarification. In that case, the user may be prompted to provide additional input with respect to said given one of the features via a question formulated in natural language. Such an approach can conveniently be used to supplement user-based inputs, when needed.

Preferably, the dynamic dataset values include values of several quantities for each feature of said features. I.e., a set of quantities is mapped to each feature. Such quantities may notably represent an importance of and/or a preference for said each feature, as perceived by the user. In addition, one of said quantities may represent a clarity of said each feature. The clarity is determined by the system according to values of the dynamic dataset values. So, clarity is evaluated partly based on the user inputs (which impact the dynamic dataset values) and partly by the system, which analyses the dynamic dataset values. Eventually, features that may benefit from clarification can be identified based on the corresponding clarity values.

In embodiments, the method further comprises, after ordering the items, logging the updated dynamic dataset values and, preferably, an outcome of the operation performed (at each cycle). This, eventually, makes it possible to obtain a history of the updated dynamic dataset values (and, preferably, outcomes of operations performed during the computational cycles). This way, features that require clarification can be identified based on the obtained history.

In preferred embodiments, the method further comprises, upon completing the computational cycles, receiving a user selection of a given item of the items in the array displayed during a last computational cycle. Then, in response to receiving said user selection, the method may instruct to display the given item, together with a description thereof. This description includes given features associated with the given item, where (at least some of) the given features are instructed to be displayed as user-selectable, in-place features.

In embodiments, the method further comprises storing, for each of a plurality of users, one or more of the dynamic datasets obtained throughout the computational cycle. In addition, optimal initial values for the dynamic dataset are determined based on values of the stored one or more of the dynamic datasets.

According to another aspect, the invention is embodied as a computerized system. The system comprises processing means and a primary storage including a main memory, the latter connected to the processing means. The system further comprises a secondary storage storing computerized methods. The system is adapted to load the computerized methods in the main memory and run the loaded methods thanks to the processing means, whereby the system is configured to perform all the steps of the method according to any of the above embodiments.

Preferably, the system is further configured to display a GUI and run software components (at each computational cycle) in an asynchronous manner and as atomic operations to perform respective processes controlling, at least partly, said GUI. In operation, the respective processes allow said input of the user to be received and the user to be prompted to provide said further input (at each cycle).

According to a final aspect, the invention is embodied as a computer program product for enabling a user to interact with a database associating items with features. The computer program product comprises a computer readable storage medium having program instructions embodied therewith. The program instructions are executable by processing means of a computerized system, so as to cause the processing means to perform all the steps of a method according to embodiments described above.

### BRIEF DESCRIPTION OF THE DRAWINGS

These and other objects, features and advantages of the present invention will become apparent from the following detailed description of illustrative embodiments thereof, which is to be read in connection with the accompanying drawings. The illustrations are for clarity in facilitating one skilled in the art in understanding the invention in conjunction with the detailed description. In the drawings:

FIGS. 1A and 1B are diagrams illustrating the main components of a computerized system according to embodiments. The system notably comprises a frontend system and a core system (FIG. 1A). FIG. 1B provides a more detailed description of the system;

FIG. 2A simplistically represents a database associating items (here second-hand smartphones) with features (fabrication year, make, price, etc.), as involved in embodiments.

FIG. 2B shows an example of a one-hot encoded matrix obtained from the features shown in FIG. 2A;

FIGS. 3A and 3B are flowcharts illustrating high-level steps of a method of enabling a user to gradually interact with a database, according to embodiments. FIG. 3A pertains to preprocessing and preliminary steps, while FIG. 3B depicts core computational steps performed at each computational cycle of the method;

FIG. 4 is a flowchart showing a temporal sequence of events, involving a user, a user device, software components running at the user device, and a calculation core, as in embodiments. The timeline is oriented top to bottom;

FIGS. 5A to 5C schematically illustrate views of a graphical user interface displayed to a user during her/his journey, as involved in embodiments. An array of potentially matching items is displayed to the user, together with selected features of the items, where some of these features are selectable, in-place features (FIG. 5A). The user may select any of these features to provide further inputs to the algorithm. For example, selecting one of these features may prompt the user to enter preferences (FIG. 5B). Moreover, the algorithm may occasionally invite the user to respond to a question selected by analysing previous inputs from the user (FIG. 5C); and

FIG. 6 schematically represents a general-purpose computerized unit, suited for implementing one or more method steps as involved in embodiments of the invention.

The accompanying drawings show simplified representations of systems, devices, or components thereof, as involved in embodiments. Similar or functionally similar elements in the figures have been allocated the same numeral references, unless otherwise indicated.

Computerized systems, methods, and computer program products embodying the present invention will now be described, by way of non-limiting examples.

### DETAILED DESCRIPTION OF EMBODIMENTS OF THE INVENTION

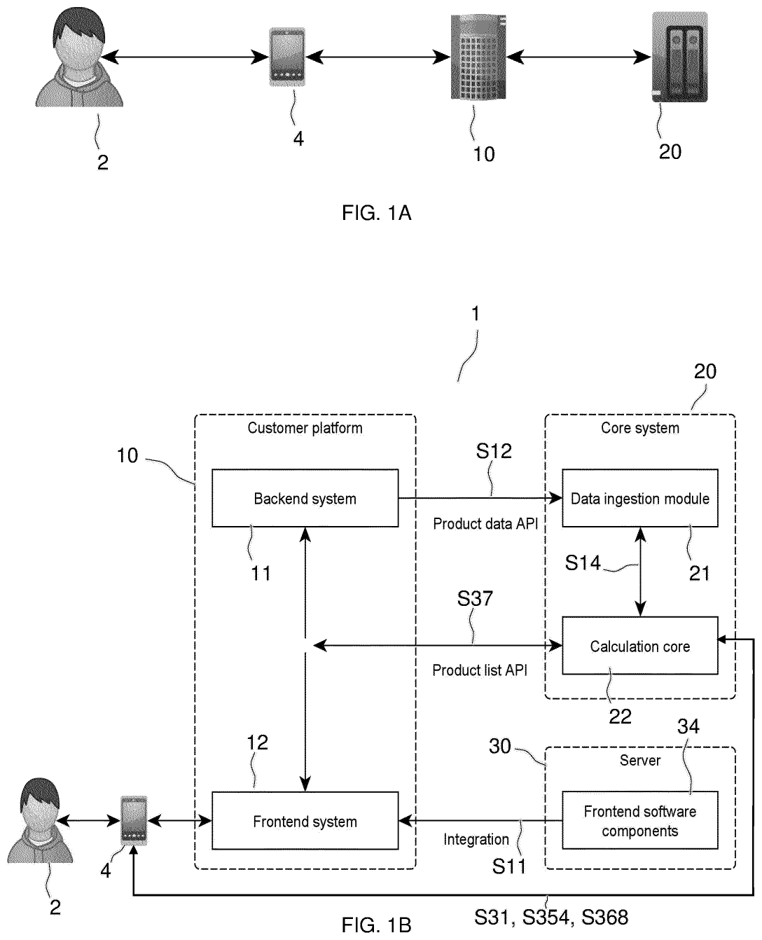

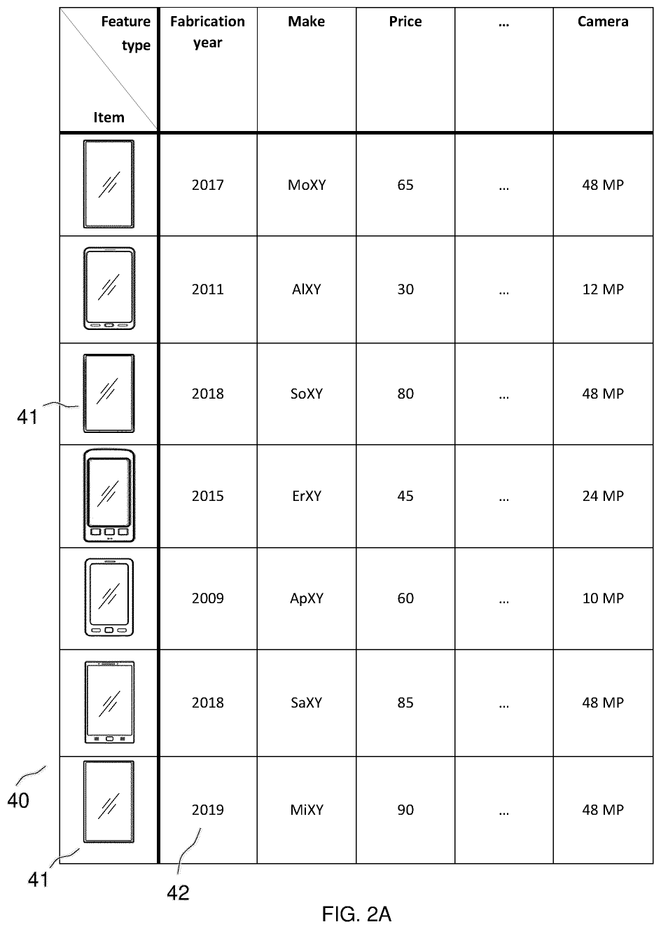

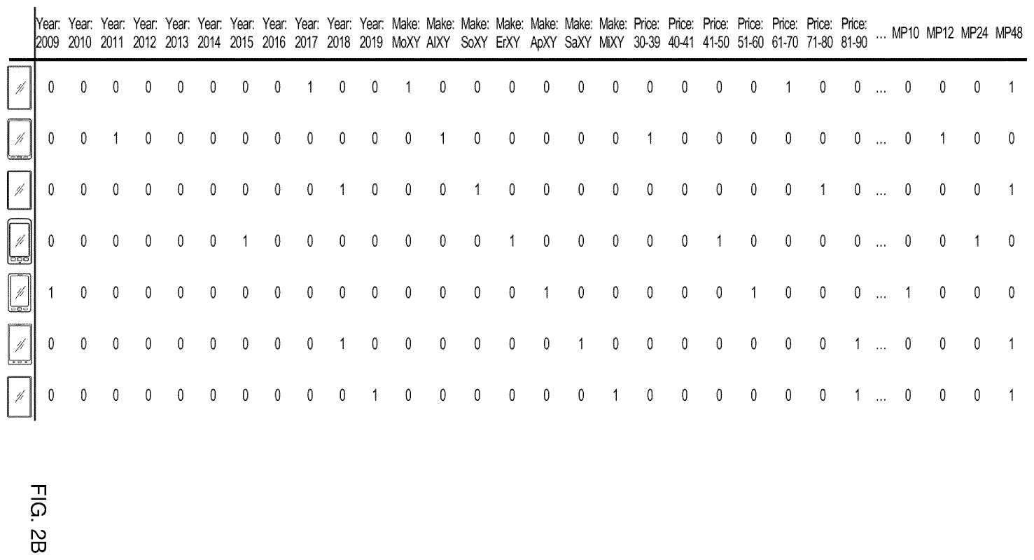

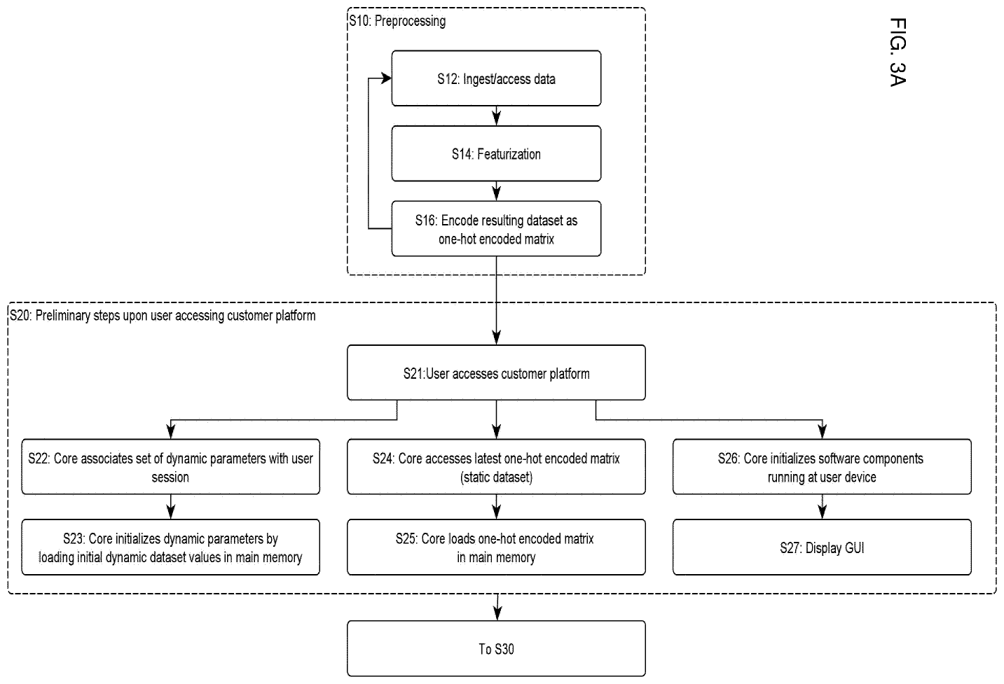

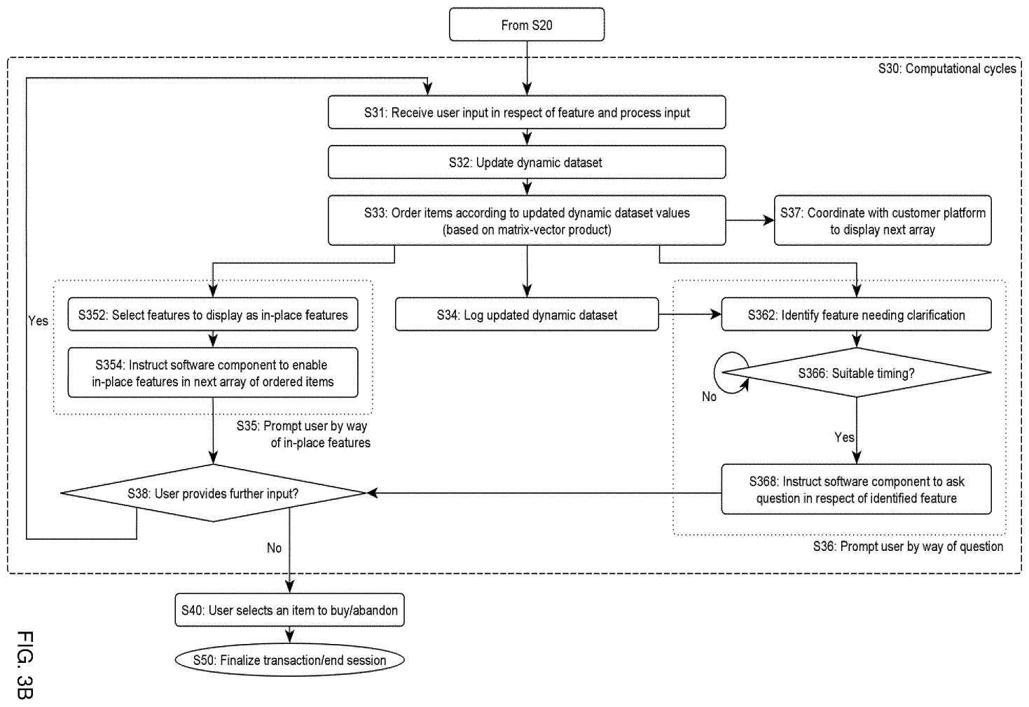

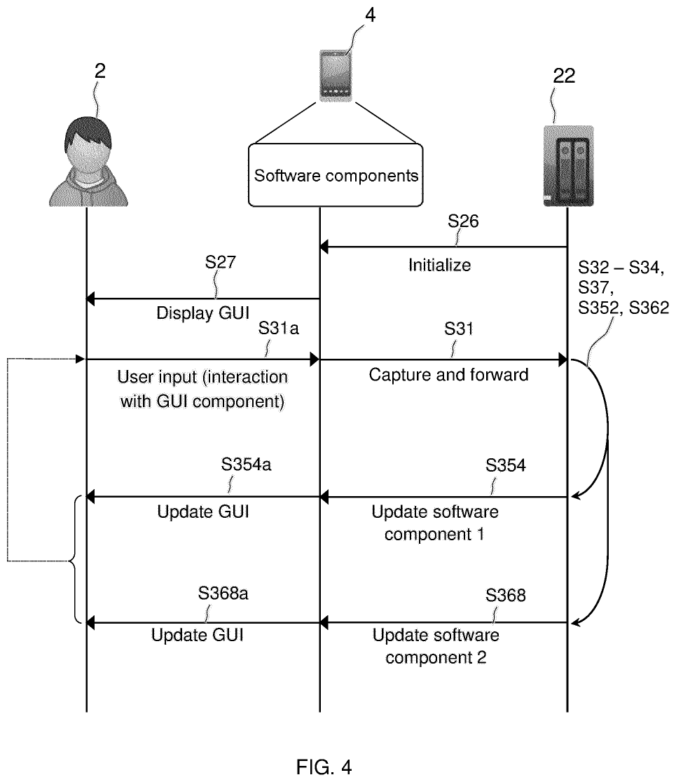

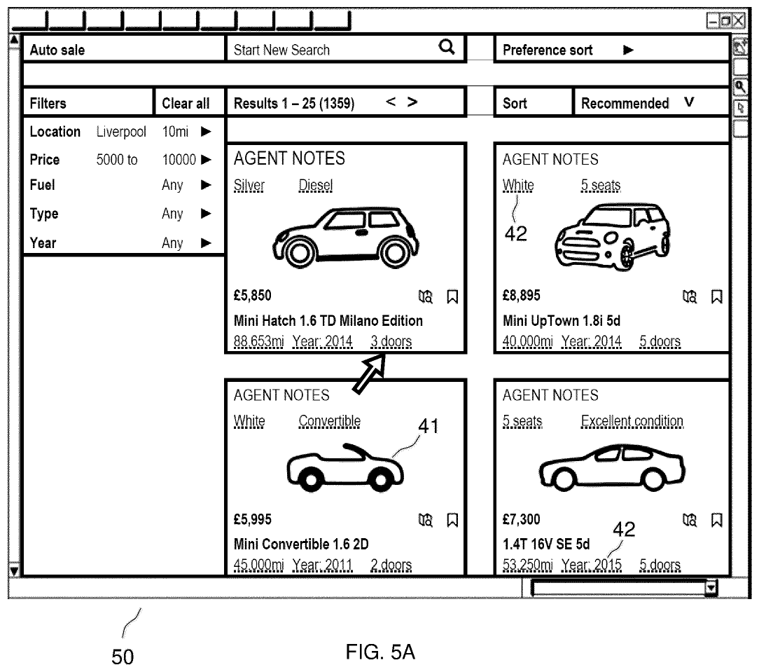

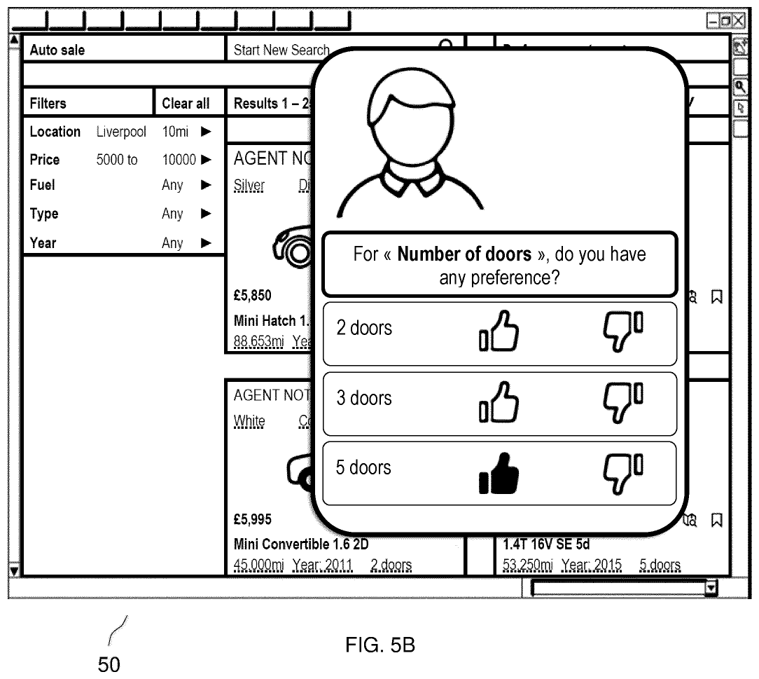

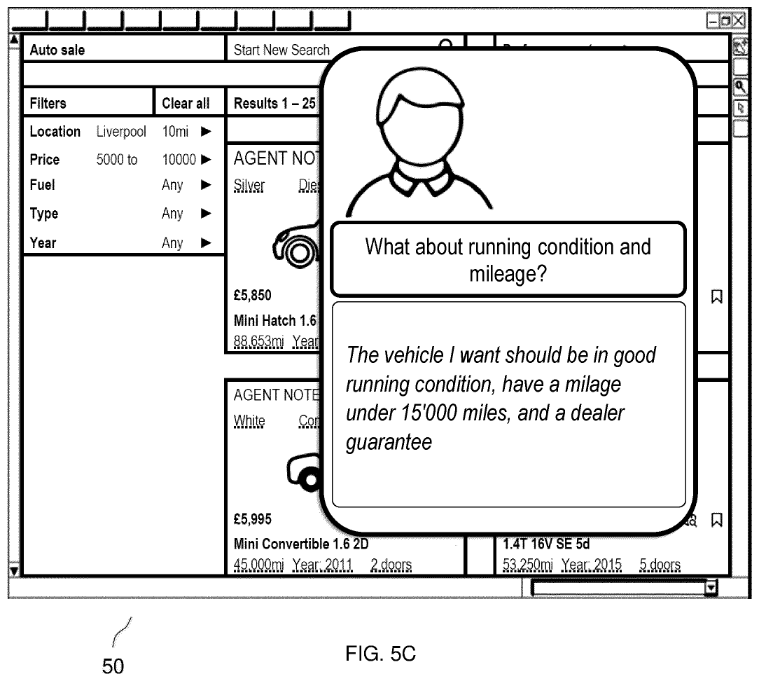

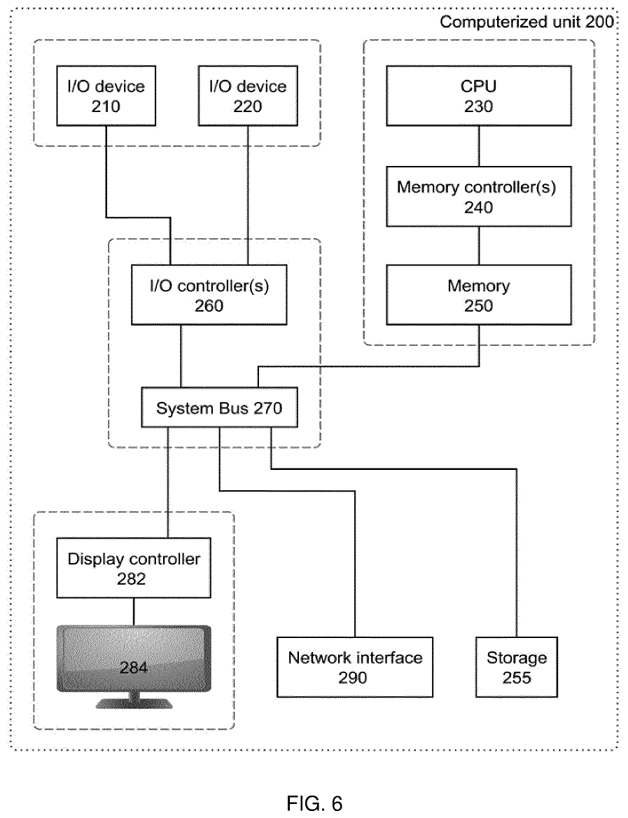

The following description is structured as follows. First, general embodiments and high-level variants are described in section 1. Section 2 addresses more specific embodiments (subsection 2.1) and technical implementation details (subsection 2.2). The present method and its variants are collectively referred to as the “present methods”. All references Sn refer to methods steps of the flowcharts of FIGS. 3 and 4, while numeral references pertain to components of the system shown in FIGS. 1A and 1B, the database shown in FIG. 2A, the graphical user interface shown in FIGS. 5A-5C, and the computerized unit shown in FIG. 6.

### 1. General Embodiments and High-Level Variants

In reference to FIGS. 1-4, an aspect of the invention is first described, which concerns a method of enabling a user 2 to interact with a database 40.

The database associates items 41 with features 42. A simple example of such a database is shown in FIG. 2A. Items can be any articles or products, such as consumer goods or other objects, virtual objects, services, etc. Features refer to characteristics or attributes of the items 41. For cars, such features 42 may notably include the price, make, model, variant, colour, etc. For televisions, they may include the screen size, manufacturer, screen type, colour, and price, etc.

The method comprises accessing S12 the database 40 to obtain an association of the items 41 and the features 42. This association is captured S16 as a static dataset, which reflects an association between multiple items and multiple features, where each item is typically associated with multiple features. So, the static dataset captures useful relations between items and features, as needed in the subsequent steps. Such associations may normally be extracted or inferred by reading the database, which typically involves conversions and text or string analysis. New features (not identified as such, be it implicitly or explicitly, in the initial database) may possibly be discovered, using advanced methods described later in detail.

The items may be captured by means of unique identifiers, or they may be omitted (e.g., each item corresponds to a respective row of a matrix representing the static dataset). The features 42 can eventually be captured as (sets of) numerical values, even if such features initially comprise text or other types of data. A certain feature type (e.g., colour) may lead to different (sets of) values. Feature values can typically be encoded as a set of discrete values (e.g., binary values or values spanning or delimiting a range of values). In that respect, the static dataset is preferably encoded as a one-hot (or one-cold) encoded matrix, which preferably has constrained dimensions, for reasons explained later. This dataset is said to be static inasmuch as its values normally remain unchanged during the performance of the computational cycles S30. Note, however, that the static dataset may occasionally be updated. Still, the static dataset remains static throughout several cycles S30.

Once the static dataset is available, it is loaded (at step S25) in the main memory 250 of a computerized system 1, e.g., at the beginning of every new user session. Note, replicas of the same static dataset can be used for many user sessions run concurrently on a same computerized system. Multiple users can for instance interact with the same core system 20, by leveraging multithreading, parallelization, or virtualization techniques, which techniques are known per se.

In addition, a dynamic dataset is assigned S22 to the current user session. As opposed to the static dataset, which remains static throughout several computational cycles S30, the dynamic dataset is updated at each cycle. The valuations that it includes are meant to capture characteristics of the user progression. Such valuations reflect attributes of the features (e.g., qualities as perceived by the user) and/or a status of such features, as determined by the system in view of inputs from the user.

The dynamic dataset is initialized at step S23, whereby initial values of this dynamic dataset are loaded S23 in the main memory of the system 1.

Several computational cycles are subsequently performed S30 at the computerized system 1. Such steps accompany the progression of the user 2; the cycles reflect the gradual interactions of the user with items and features as captured in the static dataset. Each of the cycles S30 can be decomposed into three steps, as described below.

First, upon receiving S31 an input of the user 2 in respect of one or more of the features 42, the dynamic dataset is updated S32 according to the received input. As a result, updated values of the dynamic dataset values are stored in the main memory 250. The updated dynamic dataset values represent current valuations of the features 42 of the items 41.

Second, the items 41 are ordered S33 according to the updated dynamic dataset values. More precisely, this ordering is achieved by performing an operation involving two operands. The two operands are obtained from the static dataset and the updated dynamic dataset, respectively. That is, a first operand is obtained from the static dataset (a large object reflecting associations of items and features), while a second operand is obtained from the latest dynamic dataset (a smaller object capturing characteristics of the progression of the user). In general, such operands can be regarded as certain representations of the static dataset and the dynamic dataset. These representations may possibly require some transformations, as explained later.

Using such operands, the items may be rated thanks to a simple operation (e.g., a matrix-vector product, which can efficiently be performed in-memory) and then accordingly ordered. The two operands are accessed from the main memory 250 for the purpose of performing the operation. That is, this operation can be performed offline (at each cycle), i.e., without requiring to query the database. Nevertheless, the outcome of this operation allows the items 41 to be rated and accordingly ordered S33.

Third, the method instructs S354, S368 to prompt the user 2 to provide a further input in respect of one or more of the features 42 associated with at least one of the items 41. For example, item features (or a selection thereof) may be displayed to the user as user-selectable objects (e.g., clickable objects, including links), which passively prompt the user to select such objects and thereby be invited to provide further inputs. As another example, the method may instruct to actively prompt a user, e.g., by asking a question in respect of a feature that may benefit from clarification, in view of past inputs of the user. In both cases, such prompts make use of information contained in the latest dynamic dataset (at least), as exemplified later.

Moreover, the present method instructs, at one (at least) of the cycles, to display S37 an array of at least a subset of highest-ranked items 41 of the ordered items together with features 42 associated with each of the displayed items, by virtue of the association obtained earlier. This array does not need to be displayed at each cycle, although it may be. Whether to do so may for instance be decided by the user, who may, e.g., click a corresponding action button of a graphical user interface (GUI).

The user is prompted to provide a further input at the end of each cycle S30. So, a computational cycle starts by receiving a user input in respect of a feature and ends by prompting (either passively or actively) the user to provide a further input in respect of a feature. The user may accordingly provide a new input (S38: yes), which triggers another cycle S31-S38. I.e., upon receiving a new user input, the dynamic dataset is accordingly updated S32, and the items 41 are subsequently re-ordered S33, and so on, hence the gradual (or stepwise) progression of the user 2. The method further causes to display an updated array of items (with associated features) at some point, be it during the current cycle or a subsequent cycle. Because the updated array is not necessarily displayed during each computational cycle, more than one user inputs could be received and processed before displaying an updated version of the array. Moreover, the user may possibly provide several inputs (in respect of one or more features) at a same time, e.g., using a same pop-up selection menu.

Such computational cycles S30 may notably be performed at a calculation core 22 of a core system 20, communicating with a customer platform enabling a web frontend, as in embodiments described later in detail. Whether and when to display the updated array is typically coordinated S37 by the calculation core 22, in conjunction with the frontend system. In variants, the computational cycles may be performed locally (e.g., at the customer platform 10) or, even, be pushed to the user device 4, its processing capabilities permitting. In other variants, such cycles S30 may be jointly executed at several computerized devices 4, 10, 20.

In all cases, several computational cycles are performed. For example, two cycles may be performed as follows. A first user input is received at step S31. Then, the dynamic dataset is updated step S32 according to the first input received, which gives rise to a second set of values. The second set of dynamic dataset values is, as a whole, distinct from the initial dynamic dataset (at least one value has been modified). Next, a first ordered (i.e., ranked) array of at least a subset of the items 41 may possibly be displayed to the user, together with selected features 42 of the items 41. This array has been ordered according to the updated dynamic dataset values, i.e., the second set of values. In addition, the user 2 is prompted to provide a second input in respect of a given feature (e.g., a preferred colour). Upon receiving S31 the second user input, the dynamic dataset is once more updated S32 (this time according to the second input received), which gives rise to a third set of dynamic dataset values. Eventually, a second array of a subset of the items 41 may be displayed, where the second array has been re-ordered according to the latest set of dynamic dataset values. Such steps can be repeated as needed, to ensure a smooth user progression.

At any time, the user may, upon selecting a particular item, be led to a detailed description of the selected item. For instance, this description may passively prompt the user to select a further feature and provide a further input, which may, in turn trigger, a re-ordering of the items.

Eventually, one item may be selected S40 by the user, who may then, e.g., proceed to finalize S50 a transaction, as in online shopping applications. The user may also possibly abandon the current session.

A user input will typically concern one feature at a time, although a given user input may possibly impact several features at a time, as noted earlier. However, before the very first cycle S30, the user may be invited to initiate the process and specify several features at a time, e.g., by formulating a query in natural language or using traditional filters. However, after having initially set the filters, the user will be able to provide stepwise user inputs (as per the present method), instead of only modifying the filter settings. That is, embodiments may propose the user to rely on both filters and stepwise interactions.

According to the proposed approach, each user indirectly interacts with the database 40 thanks to computational cycles performed S30 in-memory, i.e., without it being necessary to query the database. I.e., no database query is necessary after having initially accessed S12 the database to obtain the static dataset (at least not to perform the cycles S30) for the purpose of re-ordering S33 the items. This is advantageous given the typically large footprints of contemporary databases, especially databases of items such as consumer goods. Rather, all the core computational steps S30 are performed in-memory, thanks to processing means interacting with the main memory (i.e., the primary storage of the core computational system 20) only, without it being needed to access the database (or a secondary storage). This allows for improved execution speed and requires little data communication bandwidth.

This being said, the database may need be occasionally re-accessed, as in embodiments. For example, displaying the array may require retrieving data from the database, although this is typically performed by a backend system housing the database, rather than by the computerized system performing the computational cycles S30. In that case, the backend system typically needs to pass portions of the array to a frontend, as the GUI does typically not display more than a modest number of items at a time, e.g., through a pagination approach or a lazy loading as the user scrolls down the array. So, limited database access is needed in that case, while limited data exchanges are required between the core and the backend, since the core only needs to pass S37 the list of the reordered items to the backend. Also, some applications may require or benefit from a punctual refresh of the static dataset, to update values thereof. Moreover, an adaptive scheme may be contemplated, which involve a dynamic featurization, requiring infrequent access to the database. However, even in such cases, several computational cycles will likely be completed before querying the database anew. In all cases, at least some of the computational cycles S30 are preferably performed without querying the database 40 at all or accessing some secondary storage.

The present methods also have benefits in terms of user experience. According to the proposed approach, the dynamic dataset values are gradually updated, which allows a progressive, personalized search (the dynamic dataset values depend on the user inputs). Compared to traditional filter-based approaches, the proposed method allows a more natural progression of the user, step by step, during which the array is ordered S33 according to a dynamic dataset that is regularly updated according to the collected user inputs. In practice, the user is prompted to interact with directly visible GUI elements (suitably placed and/or timely triggered), rather than having to go back to a filter menu. Thus, the search progression proposed herein favourably impacts the user experience, while being computationally efficient. This is the reason why the computational cycles S30 may possibly be pushed to the user device 4, as in embodiments.

Various optimizations can be contemplated. To start with, the operation may be performed as matrix-vector dot product. To that aim, the static dataset is preferably encoded S16 as a one-encoded matrix, i.e., a one-hot encoded matrix or a one-cold encoded matrix. In both cases, the matrix elements are constrained to have one of two binary values. One-hot encoding and one-cold encoding are collectively referred to as “one-encoding” in the following. Still, the embodiments described below mostly assume that the static matrix is obtained as a one-hot encoded matrix, for the sake of illustration.

Features are encoded as columns of binary values, in view of the matrix-vector dot product to be subsequently performed. Various types of one-encoding processes can be contemplated, these notably depending on how the continuously varying features (such as price) are encoded. The encoding is performed based on the associations obtained earlier, so as to map the latter into a mathematical object, which is stored as a correspondingly structured dataset in the main memory (just like any other mathematical object used in embodiments). The aim is to encode which item has which feature. The features are preferably encoded into M columns of binary values, where M is larger than or, at the very minimum, equal to the number of features. Enforcing legal combinations of binary values in each column (e.g., each one-hot encoded column has only one high bit value, all the other column elements having the low bit value) requires each column to have M elements, which implies M rows for the matrix. Yet, the encoding process is preferably constrained, so as for the resulting matrix to have a number of rows corresponding to the number of items (seven in the example of FIG. 2A). So, the resulting matrix is an N×M matrix, having N rows and M columns (N>1 and M>1), where items correspond to respective rows of the matrix. This constraint forces the encoding process to tolerate illegal combinations of binary values on columns of the matrix. Of course, the rows may also comprise more than one high bit value and more than one low bit value. As such, this encoding process consistently reflects that one item can have more than one feature and each feature may possibly be present in more than one item.

In other words, the matrix is preferably obtained as an N×M matrix, having N rows and M columns, where each item 41 is associated with a respective row, by encoding the features 42 into the M columns according to the associations discussed earlier. Note, if m_{f} is the number of encodings (columns) of feature f, then M is the sum of the m_{f} values over f. In general, we expect N>M. E.g., second-hand car databases typically include tens or hundreds of thousands of items, having a few hundreds of features, which can typically be suitably encoded into a few thousands of columns. So, as illustrated in the above example, one feature may require more than one columns to be suitably encoded.

For example, the encoding process may separately encode each of the features to obtain respective matrices of N rows each. The respective matrices are then concatenated along their rows. That is, the matrix is preferably obtained as a combination of multiple one-encoded sub-matrices, where each sub-matrix encodes a respective feature. The sub-matrices are concatenated side-by-side, so as for the resulting matrix to have a same number of N rows, the latter corresponding to respective items. This makes it easier to update the features: whenever a new feature is discovered, as in embodiments recited below, a corresponding sub-matrix can easily be appended to (or prepended, inserted in) the already existing matrix.

The one-encoding process allows a compact storage and representation (in the main memory) due the sparse nature of the one-encoded matrix and the resulting ability to use efficient compression algorithms. Note, the static dataset may already be obtained S16 as a compressed representation of the one-encoded matrix. In that case, a compressed representation of the matrix is loaded S25 in the main memory 250, prior to performing the computational cycles. Also, the first operand may be identical to the static dataset. However, the first operand is accessed from the main memory for the purpose of performing the operation at step S33. So, in that case, this operation is performed based, on the one hand, on the compressed representation of the matrix (as accessed from the main memory) and, on the other hand, the latest dynamic dataset, at each of the computational cycles.

The encoded matrix is compatible with, and preferably optimized for, the subsequent matrix-vector operation S33. For example, the static matrix may be stored and loaded using, e.g., a compressed sparse column (CSC) or compressed sparse row (CSR) format, which are particularly efficient for matrix-vector products. So, a one-encoding may not only allow a compact representation in memory but, in addition, it may further enable a fast operation S33. Relying on compressed rows is preferred where only a subset of the items is used at a time, as noted earlier. For completeness, the one-encoding process will normally be devised so as to allow a sufficient accuracy of representation of continuously-varying features. The latter can be quantized in steps, using an appropriate granularity.

FIG. 2B shows an example of a one-hot encoded array, where one column is created for each feature value. The feature values are obtained thanks to a suitable mapping, where continuously varying values (such as price) are sorted in contiguous ranges. The number M of columns corresponds to the total number of feature values taken in consideration by the encoding algorithm to achieve a certain mapping of the initial features. The columns are not constrained to have a single high (1) bit and all the others low (0). I.e., several high bits are allowed. The resulting matrix is a 7×M matrix. The table headings are not encoded but may possibly be captured as metadata of the dataset capturing this matrix, if necessary.

As final remarks, the mapping of the feature values may be devised in accordance with GUI features as enabled by the frontend independently from the core. I.e., the same ranges as allowed by GUI components originating from the customer platform should preferably be considered for mapping the features. The encoding is preferably performed S16 once for all (subject to possible updates), i.e., prior to starting S21 any user session. Several types of conversion may be needed, prior to encoding the matrix (e.g., to convert strings and other non-numeric data into numbers, for example). For example, hash functions may be used to convert features (e.g., strings) into respective numbers. Moreover, feature extraction (in a machine learning sense) may also be used, e.g., to convert given types of features into vectors. Any update S16-S12 to the initial database may trigger a re-encoding S16, or a complementary encoding (e.g., to insert/append a new sub-matrix), as assumed in FIG. 3A.

Several variants can be contemplated. For example, instead of matrix-vector products, the present methods may rely on vector dot products and extract or encode features as respective vectors (e.g., one-encoded vectors), without necessarily assembling them into a matrix. Alternative mathematical representations of the static and dynamic datasets may possibly be devised. Similarly, other types of operations (e.g., other inner products, projections, etc.) may be contemplated, to eventually allow the items to be suitably ordered. However, it is preferred to rely on matrix-vector products as these are easily scalable and updatable, and allow most efficient computations in-memory, especially when using one-encoded matrices, which can be substantially compressed. Of course, transposed definitions of the present matrices and vectors may be used in place of the definitions introduced above, whereby the items would be mapped to columns and the features encoded into rows of the matrix, yielding mathematically equivalent results.

Dynamic dataset. The dynamic dataset may include one or more values per feature. I.e., a set of more than one value may possibly be assigned to each features. In general, the dynamic dataset can be regarded as a vector, where each vector element pertains to a respective feature and includes one or more values. For example, each vector element of the dynamic dataset may include two or three values. Such values may notably reflect quantities such as a preference for and/or an importance of a feature, as perceived by the user. Additional values may be stored as part of the dynamic dataset. In particular, each vector element of the dynamic dataset may include a quantity that reflects the clarity of a corresponding feature. Clarity is determined by the algorithm (and, to that extent, reflects the viewpoint of the system), based on previous user interactions and inputs (or the lack thereof). For example, a given feature, not yet valued by the user, may be regarded as having an unclear status (e.g., in comparison with usual valuations by other users) by the system, whereas a feature already valued by a user may be regarded as having a clear status. Like the preference and importance, the clarity valuation is preferably nonbinary. E.g., the clarity may possibly take any value between 0.0 (meaning unclear) and 1.0 (meaning clear). Likewise, the importance of a feature may range from 0.0 to 1.0, although other types of mapping may be preferred (e.g., ranging from 0.0 to infinity or from 1 to infinity, where the importance is used to scale preference values, as exemplified later). The preference may for instance range from −1.0 to +1.0, e.g., to reflect disliked (<0.0) and liked (>0.0) features. In the above examples, the ranges are inclusive. The preference typically results from user inputs such as Like/Neutral/Dislike, etc. The clarity quantities are typically adjusted by the algorithm, in view of user inputs. The importance of a feature is preferably adjusted by the algorithm in accordance with the level of user interactions observed with that feature, although it may also be directly adjusted by the user. Note, the clarity, preference, and importance, can all be regarded as variables of the model inasmuch as their values may change from one feature to the other. Once valued, however, such variables can also be regarded as parameters impacting the values of the vector elements of the dynamic vector (the dynamic operand). In all cases, the clarity, preference, and importance values represent quantities, which depend on the user interactions.

Yet, not all the elements contained in the dynamic dataset may be needed to obtain the dynamic operand (e.g., the dynamic vector) required for performing the operation at step S33. For example, the clarity may be discarded. In that case, the clarity values do not impact the ordering step S33. Rather, this ordering may solely be based on the importance of and preference for each feature. Clarity may serve another purpose, as explained later. For example, the vector elements of the dynamic operand may be obtained as a product of the values capturing the importance and the preference (for each feature) in the dynamic dataset. That is, the more preferred and the more important a feature for a user, the more weight it will have. Thus, items that include such a feature will obtain a higher rank, as a result of the matrix-vector product. Similarly, not all the static dataset values may be taken into account to form the static operand. For example, the static dataset may include metadata that are not explicitly used for obtaining the static operand. So, the static/dynamic operands are obtained from the static/dynamic datasets, but the resulting operands may differ from these datasets.

Nonbinary numeral system. As illustrated above, the dynamic dataset values are preferably defined according to a nonbinary numeral system. That is, the corresponding quantities may take more than two values. They may for instance be real numbers (e.g., spanning a given interval, as illustrated above) or integer numbers, which may potentially take at least three values. This makes the subsequent ordering S33 of items more meaningful to the user. Indeed, a nonbinary valuation system results in staircasing the resulting scores obtained for the items, as illustrated in a simple example below. On the contrary, a mere binary valuation system (as obtained with usual filters) only allows the algorithm to identify matching items, without discriminating between the matching items. More precisely, no meaningful order can be inferred from several items that all match the same features, unless a heuristic is used, which, e.g., automatically rates features that the user has not valued yet, thanks to learned or average values, as in less preferred variants.

For instance, in traditional filter-based approaches, converting the filter settings into SQL statements often result in that only those items that meet all criteria are retrieved. The retrieved items are, by definition, of equal rank order with respect to the user query (as embodied by the filter settings), such that the results displayed to the user are not necessarily relevant. Often, an over-constrained (respectively under-constrained) query returns no (respectively too many) matching items. This obliges the user to return to a filter menu to edit the initial filter settings, which often causes frustration.

User prompts. The features for which the user is prompted to provide further inputs may be identified thanks to any suitable algorithm, as exemplified later in reference to FIGS. 5A—5C. Such features can for instance be displayed in a suitable GUI 50, using any suitable visual cue (e.g., selectable links, pop-up windows, and/or other widgets), i.e., any GUI component that enables the user to perform a function, as known per se. User inputs are preferably collected via software components 34 delivered by the frontend system 12 to the user device 4 and running at the user device. Such components allow a core system 20 to remotely control (at least partly) the GUI 50. For example, a user 2 may be led to provide inputs via selectable, in-place features, displayed together with corresponding items as part of the array, see FIG. 5A. I.e., selecting an in-place feature may trigger a menu inviting the user to rate this feature (e.g., as more or less important, more or less preferred, etc.), so as for the resulting values to be valuated according to a nonbinary system, FIG. 5B. In variants, or in addition to in-place features, the user 2 may timely be invited to respond to questions automatically selected in respect of given features.

All this is now described in detail, in reference to particular embodiments of the invention. To start with, the operation performed at step S33 is preferably performed as a matrix-vector product, as noted earlier. Indeed, as it may be realized, a mere dot product of a matrix and a vector allows relative valuations to be obtained for each of the features, based on which the items can be subsequently ordered. That is, a first operand (also referred to as a “static operand” or “static matrix”) is obtained as a matrix from the static dataset, prior to performing the several computational cycles, while the second operand is obtained (at each cycle) from the dynamic dataset, as a vector. The latter is referred to as a “static vector” or “first vector” in the following. The first (static) vector is dimensioned consistently with the matrix, so as to allow a matrix-vector product. The rows of the matrix preferably correspond to distinct items, whereas the columns normally correspond to suitably encoded features values, as assumed in FIG. 2B. As noted earlier, each vector element of the first vector may notably be obtained as a product of the importance and preference values of the corresponding feature in the dynamic dataset, while the clarity values are not taken into account (for now).

The matrix-vector product results in a second vector, which represent valuations (i.e., score) of the items. Relying on a matrix-vector product allows an easy and quick operation, which has a low computational cost and can fairly easily be performed in-memory. Eventually, the items 41 are ordered S33 according to the second vector obtained, at each cycle S30.

As explained earlier, the static operand is preferably obtained as a one-encoded matrix. This allows a simple representation of the matrix, which can be substantially compressed. By contrast, the vector elements of the first vector (the dynamic operand) are preferably defined according to a nonbinary numeral system. This, interestingly, does not impact the computational efficiency of the matrix-vector products, which can be very efficiently performed in-memory, e.g., using a suited library such as Numpy (https://numpy.org, to perform the products) and Scipy (https://www.scipy.org, to handle the sparse matrices). Meanwhile, the nonbinary numeral system used for the first (dynamic) vector allows a meaningful order to be obtained, i.e., meaningful to the user. So, by contrast with traditional filter-based searches, embodiments of the invention allow a more natural progression of the user can be achieved, leading to a meaningful ordering of the items, obtained thanks to efficient in-memory operations, without querying the database or reading data from a secondary storage.

Consider a very simple example, where a static matrix m encodes three features of three items into three columns (one column encodes one feature in this example), i.e.,

$$m = ( \begin{matrix}1 & 0 & 1 \\ 0 & 1 & 0 \\ 0 & 1 & 1\end{matrix} ) .$$

This means that the first item (first row) has the first feature (“1” in the first column) and the third feature (“1” in third column), while the second item (second row) has the second feature only. The third item has both the second and third features. Assume now that the user has expressed a preference for the first and third feature (with a more marked preference for the first feature), which the algorithm respectively encodes as {2, 0, 1}. The corresponding dynamic operand (first vector v₁) is:

$${v}_{1} = ( \begin{matrix}2 \\ 0 \\ 1\end{matrix} ) .$$

As a result, one logically expects the first item to rank higher. Now, performing the matrix-vector dot product yields

$$m \cdot {v}_{1} = {v}_{2} = ( \begin{matrix}1 & 0 & 1 \\ 0 & 1 & 0 \\ 0 & 1 & 1\end{matrix} ) \cdot ( \begin{matrix}2 \\ 0 \\ 1\end{matrix} ) = ( \begin{matrix}3 \\ 0 \\ 1\end{matrix} ) .$$

According to the second vector obtained, i.e., v₂={3, 0, 1}, the first item effectively gets a higher rank (3) than the second item (0) and third item (1). Thus, ordering the three items according to 12 results in an ordered list (i.e., {item #1, item #3, item #2}) that is meaningful to the user.

Referring now more specifically to FIGS. 4 and 5A-5C, the various user interactions can be most conveniently dealt with using software components that are asynchronously run as atomic operations. That is, the computerized system 1 (FIGS. 1A, 1B) is typically configured to display a GUI 50 for the user to interact with. In order to tractably handle the concurrent processes enabling the user interactions, the present methods preferably rely on software components 34, which are run asynchronously at the computerized system 1 (e.g., at the user device 4). Such software components are further run as atomic operations to perform the various processes S31, S31a, S354, S354a, S368, S368a involved at step S30, at each computational cycle S30. These processes control, at least partly, the elements displayed by the GUI 50 and the user inputs received via the GUI. In particular, such processes allow the user inputs to be suitably received S31 by the system 1 and the user to be prompted S368a to provide a further input and, this, at each cycle. As we shall see, relying on software components further allows an easy integration of the present solutions in existing customer platforms.

A software component can be regarded as a software module. It is preferably an executable script, such as a frontend Javascript library function. The software components 34 may for instance be initially provided by a server 30 to a customer platform frontend system 12. In principle, such components may execute at the frontend 12 or at the user device 4. In preferred embodiments, however, the software components 34 are delivered by the frontend system 12 (as part of a web page script) to the user device 4 for execution thereat. On execution, the software components 34 interact with the core system 20 by directly connecting thereto. In addition, the GUI may perform additional functions, enabled by additional scripts provided by the frontend system, where such additional scripts provide usual GUI functionality. In embodiments, the software components independently connect to the core system 20 to interact therewith (independently from the frontend system). More generally, the software components may obtain updated instructions from the core system, display GUI elements, record user interactions with the GUI, and send S31 outcomes of such user interactions to the core system, for it to process S32, S33 such outcomes, as described earlier.

An atomic operation is an operation that is always executed without any other process being able to read or change the state that is read or changed during this operation. An atomic operation is effectively executed as a single step, which is beneficial in the present context, given the multiple independent processes involved, especially as the present algorithms come to update data, without requiring immediate synchronization. So, relying on asynchronous, atomic operations allows a simple implementation and management (i.e., orchestration) of the various concurrent processes involved. Note, in that respect, that if the ordering step S33 is performed in response to receiving S31 a user input, after having updated S32 the dynamic dataset, the subsequent steps (i.e., prompting the user to provide further inputs) can be performed asynchronously.

The architecture depicted in FIG. 1B assumes that the system 1 includes a frontend system 12, which can be set in data communication with a user device 4, so as to allow the user 2 to interact via a GUI 50 enabled by the frontend system. In addition, the system 1 includes a core system 20, which performs the core computations S30. Note that, in that case, the main memory 250 evoked earlier is the primary storage memory of the core system 20 or of a specific computerized unit thereof, such as a calculation core unit 22. As further shown in FIG. 1B, the frontend system 12 may typically form part of a customer platform 10, which may notably house an on-line e-commerce site or an online marketplace.

This architecture assumes that the customer offloads the core computational steps to the core system 20. This, however, may require reconciling technological constraints arising from the customer platform (e.g., in terms of website, preferred GUI elements, and other proprietary functionality) and the core computations. Now, such constraints can adequately be reconciled by using software components as described above.

Namely, while the core system 20 can perform computations involved at step S30, in particular update S32 the dynamic dataset and order S33 the items 41, the software components 34 may be delivered by the frontend system 12 to the user device 4 (e.g., embedded in a web page script) for execution thereat, so as to enable specific user interactions performed via the GUI 50. The core system 20 can otherwise be set in data communication with the software components 34, independently of the frontend system 12. This way, the software components may adequately relay information to the core system and, conversely, the core system may suitably update the software components, when needed. Thus, the core system can control (at least partly) the software components 34 run at the user device 4. As a result, the core system 20 keeps controls (at least partly) on the GUI 50. Note, the software components 34 may initially be provided by a server 30 but are then provided to the user device 4 by the frontend system 12, to run at the user device 4, where they typically need be initialized S26 by the core system 20, prior to interacting therewith.

Interestingly, above approach allows the customer platform 10 to implement its own GUI features, while retaining core functionalities ensured by the core system 20. In particular, the GUI processes enabled by the software components 14 only impose a partial control by the core system, without precluding additional processes enabled by the frontend system 12 (e.g., for a user to finalize S40, S50 a transaction). So, functions involving the core system can be conveniently separated from functions originating from the customer platform, if needed, especially where the core system focuses on the ordering of items.

Moreover, such an approach offers flexibility in operationalizing the present methods on existing customer platforms. Using software components as described above allows a “plug-in” approach that is fast and easy to implement. This approach further makes it possible to uniformize implementations of the present methods with various customer platforms.

As illustrated in FIG. 4, the software components 34 capture and forward S31 all user inputs received S31a via the GUI 50 to the core system 20. Still, the core system 20 can partly control the software components 34 by asynchronously updating S368 the latter, to enable the concurrent processes S31, S31a, S354, S354a, S368, S368a involved at step S30. To that aim, the software components 34 may comprise instructions that allow direct interactions with the core system. As further seen in FIG. 4, such updates are trigged upon receiving S31 a user input (relayed by the software components). The updates contain instructions set in accordance with the updated S32 values of the dynamic dataset. As noted earlier, asynchronous interactions are enabled between the core system 20 and the software components 34, as illustrated by the temporally shifted updates S368 in FIG. 4. Asynchronous updates are convenient, given the different internal timings of computations involved at steps S30 to trigger the various types of prompts. This makes it easier to update the various GUI elements, including, e.g., in-place features displayed as part of the array, and other prompts (such as pop-up windows), which the user may want to interact with, without undergoing delays. All the more, this results in a better user experience, since the GUI elements are updated on the fly, without imposing any synchronization delay. Moreover, successive user inputs S31a may be forwarded S31 at different times, hence the advantages of asynchronous executions of the software components.

In typical prior art methods, the software components embedded in the frontend scripts rely on the same technology as used by the frontend. On the contrary, in embodiments, the software components are built as software modules that are independent of any specific frontend framework, thanks to suitable wrappers. As such, they can be embedded into any frontend system using a ‘plug-in’ approach, even when the software components and the frontend are built using different technologies. To that aim, the software components 34 may comprise wrappers that wrap instructions allowing interactions with the core system 20, while their external layer is compatible with the frontend technology. The wrappers act as an insulation layer ensuring a safe plug-in implementation of the software components, the core functionality of which can remain essentially independent of the frontend technology. In practice, data communication between the core system 20 and the software components can be enabled thanks to web sockets.

The software components include instructions that, upon execution, listen to the core, and relay information to the core. Such instructions are executed as per running the software components 34, which notably prompts the user to provide further inputs. E.g., such instructions may activate various type of prompts (such as clickable text, or links, and questions). In addition, said instructions allow user feedback (such as responses and ratings) to be correctly captured by the software components and forwarded to the core 20.

A number of preprocessing steps may advantageously be performed, as now described in reference to FIG. 3A. Such preprocessing steps aim at suitably reading data used at step S30. The technical context may for instance be similar to that shown in FIG. 1B. I.e., the computerized system 1 comprises a customer platform 10, which includes a backend system 11, in addition to the frontend system 12. The backend system 11 is used to communicate S12 data to the core system 20, for the latter to ingest all necessary data in view of obtaining the static dataset.

The data ingestion process may advantageously be complemented by a featurization step S14 whereby the core system 20 attempts to identify existing associations and discover additional associations, in view of obtaining a suitable static dataset 40.

That is, the core system 20 may, on the one hand, identify items 41 that are associated with first features 42, which are already identified as such in the data communicated at step S12. On the other hand, the core system 10 may advantageously be programmed to automatically discover second features 42, i.e., features that are not identified as such in the communicated data. This typically requires semantic and syntactic text analysis techniques. In particular, the featurization step may possibly exploit an advanced string, text, and natural language processing framework. This framework may notably include any suitable type of text analysis such as a machine learning-based automatic text analysis and comprehension module.

Next, the core system 20 will tag the items 41 with respective features, including the newly discovered features. This way, the association captured in the static dataset (as later accessed at step S24) associate items 41 with features 42 that includes both the pre-identified features and the newly discovered features.

In addition, the core system 20 may attempt to locate, within the communicated data, natural language descriptions of the items 41 that contain said features 42, in order to activate the latter in the located descriptions. The aim is to subsequently allow a user to interact with such features via the GUI 50, given that such descriptions may be included in data retrieved by the backend system. This, eventually, allows in-place features to be suitably displayed for the user to interact with. This way, the user will eventually be able to provide further inputs in respect of any of the activated features 42, duly located in descriptions associated with the items 41.

Also, the user may happen to be prompted to formulate inputs in natural language. Analysing such inputs may for instance be done using natural-language understanding (NLU) techniques, i.e., natural-language processing (NLP) methods dealing with machine reading comprehension, by exploiting capabilities of the string, text, and natural language processing framework mentioned earlier.

Any relevant features may potentially be activated in corresponding descriptions of the items. However, only a subset of such features may be selected for display (for each respective item) as part of the array, as now discussed in reference to FIGS. 3B and 5A. That is, during each cycle, the core system 20 may select S352, for each item (or, at least, for each of the highest-ranked items 41 that are to be displayed), a subset of the features associated therewith, as per the previously obtained association S16. This selection is performed in view of displaying the selected features as part of the array, together with the corresponding items 41. Such features can be selected S352 based on a number of factors, including the latest dynamic dataset obtained at step S32, as well as, e.g., the distribution of the features between the items in the array and the presence or absence of associations between features and items. This way, the most important and/or most preferred features (for/of the user) can be displayed with the corresponding items. This comforts the user, who can immediately check the relevance of a displayed item. Still, it is also possible to select and display basic features and unusual features with the corresponding items. Basic features can for instance be the make, model, and year of a car; these are features that the user expects to see by default, irrespective of the particulars of his/her inputs or queries. An unusual feature may for example indicate that a car is a convertible, and such unusual features may trigger a useful reaction from the user, e.g., like or dislike. All such features provide the user with useful information.

At least some of the selected features may be displayed as user-selectable, in-place features. Such features are underlined with a dotted line in the views of FIGS. 5A-5C. For example, the core 20 may instruct S354 software components to enable the selected features as user-selectable features, as part of an updated array. Selectable, in-place features can be regarded as passive prompts, which implicitly prompt the user 2 to provide a further input in respect of the corresponding features. I.e., instructing S354 the software components to enable such features results in activating the functionality of the in-place features, such that the user may subsequently interact therewith. In addition to enabling the selected in-place features, some of the software components may be instructed by the core to suitably highlight those features that are part of the user's positive preferences, e.g., by simply highlighting the corresponding text in a given colour.

Preferably, when the user selects one of the in-place features, a GUI component is activated, which may for example prompts the user to rate a feature, as illustrated in FIG. 5B. By so doing (S38: Yes in FIG. 3B), the user provides S31a an input, which is forwarded S31 by a software component 34 to the core. The core 20 then processes this input during a next cycle S30. For example, the user selection of an in-place feature may trigger an invitation, e.g., in the form of a Like/Dislike pop-up menu, to rate a corresponding feature. In the example of FIG. 5A, the user selects an in-place link (“3 doors”) in the upper-left quadrant. This triggers a pop-up menu, see FIG. 5B, inviting the user to enter a preference with respect to the number of doors. In this example, the user selects a preference for a model with five doors. The corresponding feature, which previously had a neutral score (e.g., 0.0), may for example be rated+0.5 from now on. This, in turn, may trigger a re-ordering S33 of the items 41, such that car models with five doors will likely show higher ranks in the next displayed array.

In variant, a simple Like/Dislike menu is displayed. I.e., clicking an in-place link leads to an in-place popup, inviting the user to indicate a simple preference (e.g., Like/Dislike) for the particular linked feature (“3 doors”).

In addition to in-place features, questions may be raised in respect of any feature value or feature types, at any convenient time. Such a question may be triggered in order to solve a currently unclear matter. Referring back to the above example, if the user happens to like or dislike the linked feature “3 doors” (selected in FIG. 5A), as per indication provided via a simple Like/Dislike menu, then the core system may decide to ask a follow-up question, such as “For “number of doors”, do you have any further preferences?”. The user may then answer this question, e.g., thanks to a menu similar to that shown in FIG. 5B, or by way of a response formulated in natural language.

Such questions may also be triggered independently of any interaction a user previously had with an in-place feature. E.g., features for which a question is raised may also be features that have not been valued yet by the user, but for which the system has determined that additional information may be useful, e.g., because such features are typically of interest for other users, in general.

The core system 20 may notably attempt to identify S362 features needing clarification based on the latest dynamic dataset values. Indeed, as noted earlier, the core system 20 may continually update the clarity of each feature. So, a feature having a low clarity score may, from time to time, be selected for clarification. In turn, the user 2 is prompted S368a to provide additional input in respect to this feature, e.g., via a rating menu or a question formulated in natural language. Note, this question may be automatically selected and then formatted using basic text processing. This is illustrated in FIG. 5C, where the user is invited to describe a preferred condition and mileage of the vehicle. In response, the user may provide a description in natural language, as assumed in FIG. 5C. This response may then be interpreted using NLU. In variants, the user may simply be presented options, as in FIG. 5B. Typically, such questions are sparingly formulated, so as not to impair the user progression. This mechanism may for example be throttled by setting S366 a timer; the question is delayed until this timer has lapsed (FIG. 3B).

As noted earlier, the dynamic dataset values preferably include three quantities for each feature. Such quantities correspond to the importance of, and preference for, a given feature (as perceived by the user), and the clarity of each feature. While the clarity values do preferably not impact the ordering S33 of the items, they can nevertheless be used by the system to identify S362 those features that require clarification. The clarity score of each feature may notably be determined in view of the values of the other quantities (the importance of and preference) in the latest dynamic dataset. However, the clarity score may advantageously be determined in view of earlier user interactions. To that aim, the core 22 may investigate history of the dynamic dataset, and, in particular, the history of the importance of and preference. The history of the dynamic dataset values tells whether a feature has already been interacted with (and possibly valued) by the user.

Note, another quantity (or function) may possibly be stored in the dynamic dataset (for each feature), which captures the extent to which a user has already interacted with the respective feature. This quantity is adjusted in real-time by the core and the clarity value is accordingly updated. More generally, sophisticated heuristics can be devised, leading to gradual incrementations and reductions of all the quantities involved, including the clarity values.

For example, the clarity score (′ of a given feature may be initialized to 0.0 and later set to any value between 0.0 and 1.0 (inclusive) if the user expresses a choice, a preference, etc., with respect to this feature. The value of the importance/can similarly be incremented, depending on interactions and inputs (e.g., ratings) provided by the user. For instance, the outcome of the product (1−C)×I measures a need to inquire about a certain feature; the less clear and the more important the feature, the larger the result, and so the larger the need for clarification. By contrast, the score of a feature is typically measured by the product I×P. I.e., the dynamic vector elements may consist, each, of outcomes of the product I×P performed for the respective feature.

The core 22 may log S34 the successive dynamic dataset values, in order to enable heuristics as evoked above. In addition to the dynamic dataset values, the core 22 may also log S34 outcomes of operations S33 performed at each cycle and, if necessary, cache the results. This way, a previous state of the system (i.e., corresponding to a previous point in time of the user experience) may easily and quickly be recovered whenever the user happens to provide inputs that effectively result in reverting to a previous state, without having to recompute the corresponding matrix-vector product.

For completeness, the histories of the dynamic datasets (as obtained for several users throughout their journeys) may possibly be stored (anonymously, so as to preserve privacy), to learn about users' typical journeys, using statistical and/or machine learning techniques. This, in turn, may be exploited to learn suitable questions, as well as optimal initial values for the dynamic dataset, as needed at step S23.

Beyond the interaction mechanisms illustrated in FIGS. 5A-5C, various possible improvements can be contemplated. In particular, the computational cycles S30 may be modified to adaptively integrate previously unlabelled features, during the user's journey. For example, a user may be able to select (e.g., highlight) any piece of product information (text) that is wrapped by a software component, e.g., using the mouse to perform a usual click-drag. In response to this selection, the software component may display an in-place feedback menu (similar to the pop-up windows of FIGS. 5B and 5C), inviting the user to rate this piece of product information (e.g., Like/Dislike). This component then sends the user request (i.e., an input relating to the highlighted text and the corresponding rating) to the core 20, which then checks whether this request can be related to any existing feature, i.e., a feature identified as such in the latest association as obtained at the end of the featurization step S14. Doing so may again involve text analysis and NLP, e.g., to assess semantic distances between the compared features. If the user request is determined to correspond to an already existing feature, then the normal process (steps S32 and S33) is resumed. However, if the user selection cannot be related to an existing feature, then the core 20 may access and parse the initial database to determine which items include this new feature. Then, one or more additional one-encoded columns may be computed and appended to the existing matrix. The usual process S33 of matrix-vector products and ordering can subsequently be resumed. The dynamic vector need be re-dimensioned, consistently with the updated matrix, and the quantities corresponding to the new feature need be initialized.

In such embodiments, the user journey is not limited to predefined features. Instead, users can define their own features. Although the additional database access required to identify the new features slows down the processes involved at step S30 (which, so far, only involved in-memory operations), this additional cost will be moderate as such user requests will be rare in practice. Plus, such additional steps will at most be executed in respect of one feature at a time. Note, although a dynamic featurization scheme as described above is typically implemented independently for each user session, one may also capitalize on knowledge gained during such sessions to progressively expand the initial features and make such features available to subsequent users.

At any time in the navigation process, a user may select S40 one of the displayed items. This may, in practice, likely occur after a few computation cycles S30. When the user selects S40 a given item, the core system 20 may instruct to display the selected item together with a (full) description thereof. This description may include features 42 that have been previously associated with this item and activated in the corresponding description. Therefore, such features are typically displayed as user-selectable, in-place features, in the description of the selected item. Thus, the user 2 is again (implicitly) prompted to provide a further input in respect of any of the in-place features, if needed. Moreover, an additional question may be asked to the user, if necessary. Doing so may, again, trigger a re-ordering of the item. So, the user may accordingly be invited to continue the search.

Referring back to FIGS. 1A, 1B, and 6, another aspect of the invention is now described, which concerns a computerized system 1. Essential aspects of the system 1 have already been discussed in reference to the present methods. Accordingly, this system is only briefly discussed in the following.

Basically, the system 1 includes processing means 230 and a primary storage or main memory 250 that is connected to the processing means 230. The system further includes a secondary storage 255. Amongst other data and program code needed for the normal operation of the system 1, the secondary storage stores computerized methods (e.g., in the form of software code), which can be loaded in the main memory 250. In operation, the system can run the loaded methods thanks to the processing means 230. Executing the loaded methods makes it possible to perform method steps as described above in reference to FIGS. 3A, 3B, and 4.

In particularly preferred embodiments, the system 1 is further configured to display a GUI 50 and run software components 34 (at each computational cycle), in an asynchronous manner and as atomic operations. This makes it possible to perform respective processes controlling, at least partly, the GUI 50, as described earlier in reference to FIGS. 3-5C.

In particular, the computerized system 1 may advantageously include a core system 20, with a calculation core unit 22 configured to perform the core computational steps S30, see FIG. 1B. The system 1 may further include a customer platform 10, the latter including a backend system 11 and a frontend system 12. The latter enables the GUI 50, with which the user 2 interacts using a user device 4 (e.g., a smartphone, a tablet, or a usual PC). The backend system 11 is notably used to communicate data necessary for the preprocessing steps S12-S16, FIG. 3A. Interactions between the core 20 and the platform 10 are enabled thanks to suitable application programming interfaces (APIs). In particular, a first API may be involved to ingest S12 initial data, while a second API may be needed to interact S37 with the frontend and backend systems and display the re-ordered item arrays. As further illustrated in FIG. 1B, software components 34 may initially be provided by an external server 30 to the platform 10. Eventually, though, the software components are deployed by the frontend system 12 of the customer platform 10, so as to run at the user device 4. The latter can directly connect to the core 22, so as for the software components running at the device 4 to interact directly with the core 22. Such an architecture can easily be augmented: the core may similarly interact with multiple platforms 10. Each of the customer platform 10, the core system 20, and the server 30, may include one or more computerized unit 200 as shown in FIG. 6. This unit 200 is described in detail in Section. 2.2.

Next, according to a final aspect, the invention can be embodied as a computer program product for enabling a user to interact with a database, as described earlier in reference to the present methods. The computer program product comprises a computer readable storage medium having program instructions embodied therewith. Such program instructions are executable by processing means 230 of a computerized system 1, e.g., a core system 20, so as to cause the processing means to perform steps of the methods described herein. Additional considerations as to such computer program products are provided in Section. 2.2.

The above embodiments have been succinctly described in reference to the accompanying drawings and may accommodate a number of variants. Several combinations of the above features may be contemplated. Examples are given in the next section.

### 2. Specific Embodiments and Technical Implementation Details

### 2.1 Particularly Preferred Embodiments

### 2.1.1. Preprocessing and Preliminary Steps (FIGS. 1B and 3A)

Various preprocessing steps S10 are performed, as now discussed in reference to FIGS. 1B and 3A. First, the core system 20 accesses S12 the database to ingest all data necessary to obtain the static dataset. To that aim, a data ingestion module 21 of the core system 20 interacts S12 with the backend system 11 of the platform 10, via a suitable API, see FIG. 1B. The calculation core 22 may notably replicate a local version of the database of the customer platform, in any appropriate format. The core 22 accesses the (replicated) database and performs featurization at step S14, to identify all relevant associations between items 41 and features 42. This way, the core 22 is able to obtain a static dataset and encode S16 such associations as a one-encoded matrix. The calculation core 22 may, on occasions, need to re-access the database, e.g., to refresh the static dataset, and accordingly integrate new features and/or new items, or adaptively update the static dataset (during a user session) and thereby dynamically integrate new features.

In parallel, software components 34 may be provided S11 by a server 30 to the customer platform 10 (see FIG. 1B), which can accordingly assemble the components as part of a web page script, in view of delivering this script to the user device 4 for the latter to run it.

Besides preprocessing steps S10, preliminary steps are performed S20 upon the user 2 accessing S21 the customer platform 10, e.g., via a smartphone 4, see FIGS. 1A and 1B. Three flows can be delineated, which may be performed in parallel. On the leftmost path, the core 22 associates S22 a set of dynamic parameters with the current user session. Then, the core initializes S23 the dynamic parameters by loading initial values thereof in its main memory 250. On the central path, the core accesses S24 the latest available one-encoded matrix (corresponding to the latest static dataset available) and loads S25 it in its main memory 250. On the rightmost path, the core initializes S26 the software components running at the user device 4, which accordingly impacts S27 the GUI 50 displayed to the user 2.

The user 2 typically starts the search for items by using usual filters or by asking a question in natural language.

### 2.1.2 Core Computations (FIG. 3B)

From step S20, the method starts executing S30 core computational cycles, during which a first user input may be received at step S31, see FIG. 3B. This input concerns one or more given features. The calculation core 22 of the core system 20 processes S30 this input and accordingly updates S32 the dynamic dataset, to eventually obtain an updated dynamic operand (first vector). The core 22 then orders S33 the items according to the outcome of a matrix-vector product, the latter performed based on the latest one-encoded matrix S16 and the dynamic operand, as just updated S32. The successive dynamic datasets obtained at step S32 can be logged at step S34. If necessary, the outcome (second vector) of the matrix-vector product operation can be cached.

Two interaction mechanisms are depicted in FIG. 3B, such mechanisms are concurrently performed. On the one hand, the core prepares to prompt S35 the user to provide further inputs by way of user-selectable, in-place features. To that aim, it selects S352 certain features based on the latest dynamic dataset obtained and the array of highest-ranked items. It may also select basic features and unusual features, according to suited heuristics. The core 22 further instructs S37 the backend system (e.g., using a dedicated API, see FIG. 1B) to take steps to display an updated array of items (or, at least, the highest-ranked items), according to the latest ordered list of items obtained S33. Each item is to be displayed with correspondingly selected S352 features, hence the need to accordingly instruct S354 software components for them to enable such features.

On the other hand, the core may also prompt S36 the user to provide further inputs by way of a question formulated in natural language, by correspondingly instructing a software component running on the user device 4. First, the core 22 identifies S362 one or more features that may benefit from clarification, based on the latest clarity parameters as stored in the dynamic dataset (other factors may come into play). Such clarity parameters may for instance be regularly updated, by inspecting the history of (e.g., of the preference and/or importance parameters stored in) the dynamic dataset. The list of features can thus be ordered according to their clarity values. Then, the core 22 may timely instruct S368 a software component to ask S368a a question in respect of the feature having the lowest clarity value. A timing is observed S366, prior to instructing to ask such a question, in order not to overwhelm the user 2.

If the user happens to provide (S38: Yes) a further input, a new cycle S30 is started; the process loops back to step S31. Instead of providing a further input, the user may also come (S38: No) to abandon S40 the current session (which terminates S50 the session) or to select a particular item. In the latter case, an extended description of the selected item may be displayed on the GUI 50; this description may again include in-place features. Thus, the user may possibly select one of the displayed in-place features, which may trigger a menu inviting her/him to provide additional input. This, in turn, may trigger another cycle S30. The user may also finalize S50 the transaction, using GUI components provided by the frontend 12, independently from the software components 34 interacting with the calculation core 22.

Additional processes may take place (not shown) for the user to provide inputs, as explained in the next section.

### 2.1.3 Asynchronous Mechanism (FIGS. 1B and 4)

The temporal sequence shown in FIG. 4 provides additional insights into the execution of the present methods. FIG. 4 focuses on the software components executing at the user device 4 and the calculation core 22. In general, the user 2 provides S31a inputs via a user device 4 by interacting with GUI components displayed thereon. Some of these components are software components that were delivered by the frontend system 12 (as part of a web page script) but are directly interacting with the calculation core 22, see FIG. 1B. The software components are run asynchronously, as atomic operations, to ease the orchestration of the various user-interaction mechanisms involved and the integration of the present methods in existing customer platforms.

The calculation core 22 may start by initializing S26 the software components 34, something that may already impact the GUI being displayed S27 to the user at the device 4. The user then provides a first input at step S31a, which is captured by a software component and forwarded S31 to the core 22. The latter accordingly processes this input to update S32 the dynamic dataset, order S33 the items, and log S34 corresponding outcomes. In parallel, the core 22 may coordinate S37 with the backend system to update the array. The core 22 further triggers mechanisms S35, S36 discussed above and accordingly: (i) instruct S354 software components to enable in-place features as selected at step S352; and (ii) update S368 other software components for them to actively prompt the user, when needed. The software components are instructed and/or updated in an asynchronous manner. In turn, such instructions/updates cause to update S354a, S368a the GUI. After any GUI update, the user may happen to provide S31a a further input, which starts another cycle S30.

Aside from mechanisms involving software components interacting directly with the core, other user inputs may be captured by other GUI components and forwarded to the web frontend of the frontend system 12, as usual in the art.

### 2.2 Computerized Systems and Computer Program Products

Computerized systems and devices can be suitably designed for implementing embodiments of the present invention as described herein. In that respect, it can be appreciated that the methods described herein are at least partly non-interactive, i.e., automated. Automated parts of such methods can be implemented in software, hardware, or a combination thereof. In exemplary embodiments, automated parts of the methods described herein are implemented in software, as a service or an executable program (e.g., an application), the latter executed by suitable digital processing devices.

For instance, as depicted in FIG. 6, a typical computerized device (or unit) 200 may include a processor 230 and a main memory 250 (possibly including several memory units) coupled to one or memory controllers 240. The processor 230 is a hardware device for executing software, as, e.g., loaded in the main memory 250 of the device. The processor, which may in fact comprise one or more processing units, can be any custom made or commercially available processor, including CPUs and GPUs. The unit 200 further includes a secondary storage unit 255.

As a whole, the memory 250, 255 typically includes a combination of volatile memory elements (e.g., random access memory) and nonvolatile memory elements, e.g., solid-state devices and/or hard drives. The software stored in the storage element 255 may include one or more separate programs, each of which may comprise an ordered listing of executable instructions for implementing logical functions as involved in embodiments. In the example of FIG. 6, the software includes methods described herein in accordance with exemplary embodiments and a suitable operating system (OS). The OS essentially controls the execution of other computer (application) programs and provides scheduling, input-output control, file and data management, memory management, and communication control and related services. It may further control the distribution of tasks to be performed by the processing units 230. The methods described herein shall typically be in the form of executable program, script, or, more generally, any form of executable instructions.

The computerized unit 200 can further include a display controller 282 coupled to a display 284. In exemplary embodiments, the computerized unit 200 further includes a network interface 290 or transceiver for coupling to a network (not shown). In addition, the computerized unit 200 will typically include one or more input and/or output (I/O) devices 210, 220 (or peripherals) that are communicatively coupled via a local input/output controller 260. A system bus 270 interfaces all components. Further, the local interface may include address, control, and/or data connections to enable appropriate communications among the aforementioned components. The I/O controller 135 may have additional elements, which are omitted for simplicity, such as controllers, buffers (caches), drivers, repeaters, and receivers, to allow data communication.

When the computerized unit 200 is in operation, one or more processing units 230 executes software stored within the memory of the computerized unit 200, to communicate data to and from the memory 250 and/or the storage unit 255 (e.g., a hard drive and/or a solid-state memory), and to generally control operations pursuant to software instruction. The methods described herein and the OS, in whole or in part are read by the processing elements, typically buffered therein, and then executed. When the methods described herein are implemented in software, the methods can be stored on any computer readable medium for use by or in connection with any computer related system or method.

Computer readable program instructions described herein can for instance be downloaded to processing elements from a computer readable storage medium, via a network, for example, the Internet and/or a wireless network. A network adapter card or network interface 290 may receive computer readable program instructions from the network and forwards such instructions for storage in a computer readable storage medium 255 interfaced with the processing means 230.

Aspects of the present invention are described herein notably with reference to a flowchart and a block diagram. It will be understood that each block, or combinations of blocks, of the flowchart and the block diagram can be implemented by computer readable program instructions. A computer readable storage medium, as used herein, is not to be construed as being transitory signals per se, such as radio waves or other freely propagating electromagnetic waves, or electrical signals transmitted through a wire.

These computer readable program instructions may be provided to one or more processing elements 230 as described above, to produce a machine, such that the instructions, which execute via the one or more processing elements create means for implementing the functions or acts specified in the block or blocks of the flowchart and the block diagram. These computer readable program instructions may also be stored in a computer readable storage medium.

The flowchart and the block diagram in the accompanying drawings illustrate the architecture, functionality, and operation of possible implementations of one or more computerized units 200, methods of operating them, and computer program products according to various embodiments of the present invention. Note that each computer-implemented block in the flowchart or the block diagram may represent a module, or a portion of instructions, which comprises executable instructions for implementing the functions or acts specified therein. In variants, the functions or acts mentioned in the blocks may occur out of the order specified in the figures. For example, two blocks shown in succession may actually be executed in parallel, concurrently, or still in a reverse order, depending on the functions involved and the algorithm optimization retained. It is also reminded that each block and combinations thereof can be adequately distributed among special-purpose hardware components.

While the present invention has been described with reference to a limited number of embodiments, variants and the accompanying drawings, it will be understood by those skilled in the art that various changes may be made and equivalents may be substituted without departing from the scope of the present invention. In particular, a feature (device-like or method-like) recited in a given embodiment, variant or shown in a drawing may be combined with or replace another feature in another embodiment, variant or drawing, without departing from the scope of the present invention. Various combinations of the features described in respect of any of the above embodiments or variants may accordingly be contemplated, that remain within the scope of the appended claims. In addition, many minor modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims. In addition, many other variants than explicitly touched above can be contemplated. For example, other system configurations can be contemplated, where the present methods are executed by a single computerized system, or by a computerized unit communicating with a user device, for example.

1. A method of enabling a user to interact with a database associating items with features, wherein the method comprises:
accessing the database to obtain an association of the items and the features as a static dataset;
loading the static dataset and initial values of a dynamic dataset in the main memory of a computerized system; and
performing several computational cycles at the computerized system, each of the cycles comprising:
upon receiving an input of the user in respect of one or more of the features, updating the dynamic dataset according to the received input, whereby updated dynamic dataset values are stored in the main memory, the updated dynamic dataset values representing current valuations of the features of the items;
ordering the items according to the updated dynamic dataset values by performing an operation involving two operands accessed from the main memory, the two operands obtained from the static dataset and the updated dynamic dataset, respectively; and
based on the updated dynamic dataset, instructing to prompt the user to provide a further input in respect of one or more of the features associated with at least one of the items,
and wherein
at least one of the cycles further comprises instructing to display an array of at least a subset of highest-ranked items of the ordered items together with features associated with each of the displayed items by virtue of the obtained association.

2. The method according to claim 1, wherein,
a first one of the two operands is obtained as a matrix from the static dataset, prior to performing the several computational cycles, while a second one of the two operands is, at each of the computational cycles, obtained from the updated dynamic dataset as a first vector that is dimensioned consistently with the matrix, and
said operation is performed, at each of the computational cycles, as a matrix-vector product to obtain a second vector representing said valuations, whereby the items are ordered according to the second vector.

3. The method according to claim 2, wherein
the first one of the two operands is obtained as a one-hot encoded matrix or a one-cold encoded matrix, whereby each matrix element of the matrix is a binary value that may have one of two possible values.

4. The method according to claim 3, wherein
the matrix is obtained as an N×M matrix, having N rows and M columns, wherein each of the items is associated with a respective one of the N rows, by encoding the features into the M columns according to the obtained associations.

5. The method according to claim 4, wherein
the matrix is obtained by separately encoding each of the features to obtain respective matrices of N rows each and then concatenating the respective matrices along rows thereof.

6. The method according to claim 2, wherein,
the static dataset is a compressed representation of the matrix, whereby said compressed representation is loaded in the main memory, prior to performing the several computational cycles;
the first one of the two operands is the compressed representation of the matrix, as accessed from the main memory; and
said operation is performed based on the compressed representation of the matrix accessed from the main memory, at each of the computational cycles.

7. The method according to claim 1, wherein the computerized system is configured to provide a graphical user interface, for the user to interact with, and
the method further comprises running software components at the computerized system at each of the computational cycles, wherein the software components are asynchronously run as atomic operations to perform respective processes controlling, at least partly, said graphical user interface, the respective processes allowing
said input of the user to be received, and
the user to be prompted to provide said further input.

8. The method according to claim 7, wherein:
the computerized system includes a user device of the user, a frontend system, and a core system, the latter including the main memory;
the dynamic dataset is updated by the core system and the items are ordered by the core system;
the software components are delivered by the frontend system to the user device, whereby the software components are run at the user device, so as to allow the user to interact with said graphical user interface, and
the core system is in data communication with the user device, so as for the software components run at the user device to interact with the core system and thereby perform said respective processes.

9. The method according to claim 8, wherein:
the computerized system further includes a backend system; and
instructing to display the array comprises sending a list of the ordered items from the core system to the backend system, so as for
the backend system to retrieve data associated with said highest-ranked items and send the retrieved data to the frontend system, and
the frontend system to
build a web page script including the retrieved data and the software components, and
deliver the web page script to the user device for execution thereat.

10. The method according to claim 8, wherein
the core system partly controls the software components by asynchronously updating the software components in accordance with the updated dynamic dataset values.

11. The method according to claim 7, wherein
the software components comprise wrappers that wrap instructions from the core system, and
running said software components causes these instructions to prompt the user to provide said further input.

12. The method according to claim 8, wherein
the computerized system further includes a platform, the latter including a backend system and said frontend system,
accessing the database comprises communicating data from the backend system to the core system for the latter to ingest the communicated data, and
the method further comprises, at the core system, performing featurization to obtain said static dataset by:
identifying items associated with first features already identified as such within the communicated data,
discovering second features that are not identified as such in the communicated data, using semantic and syntactic text analysis,
tagging the items with respective ones of the first features identified and the second features discovered, so as for the obtained association to eventually associate said items with features that includes both the first features and the second features,
locating, in the communicated data, natural language descriptions of the items that contain said features, and
activating the features in the located descriptions to subsequently allow a user to interact with such features via the graphical user interface.

13. The method according to claim 12, wherein said each of the cycles further comprises,
upon receiving a request of the user that the system cannot relate to any of the features,
accessing the database to search for items presenting an unlabelled feature matching this request,
updating said features, for the features to include the unlabelled feature, and accordingly updating the static dataset, for it to reflect an updated association of the items and the updated features;
loading the updated static dataset in the main memory of the computerized system and modifying the dynamic dataset consistently with the updated features;
ordering the items according to the modified dynamic dataset by performing said operation, the latter based on updated operands, respectively obtained from the updated static dataset and the modified dynamic dataset.

14. The method according to claim 1, wherein the method further comprises, prior to instructing to display the array, selecting, based on the updated dynamic dataset, at least a subset of the features associated with the highest-ranked items as per the obtained association, for the selected features to be subsequently displayed as part of the array.

15. The method according to claim 14, wherein
the selected features are instructed to be displayed as user-selectable, in-place features of the highest-ranked items, in association with respective items of said highest-ranked items within said array, and
the user is prompted to provide said further input in respect of any one of the selected features.

16. (canceled)

17. The method according to claim 7, wherein the method further comprises
identifying, based on the updated dynamic dataset values, a given one of the features that may benefit from clarification, whereby the user is prompted to provide additional input with respect to said given one of the features via a question formulated in natural language, thanks to one of the software components.

18. The method according to claim 17, wherein
said dynamic dataset values include values of several quantities for each feature of said features, said quantities representing:
an importance of and/or a preference for said each feature, as perceived by the user; and
a clarity of said each feature, as determined by the system according to values of the dynamic dataset values, and
said given one of the features is identified based on a corresponding clarity value.

19. (canceled)

20. (canceled)

21. The method according to claim 1, wherein said computational cycles are performed without querying the database.

22. A computerized system for enabling a user to interact with a database associating items with features, the computerized system comprising:
processing means and a primary storage including a main memory, the latter connected to the processing means, and
a secondary storage storing computerized methods,
wherein
the computerized system is adapted to load the computerized methods in the main memory and run the loaded methods thanks to the processing means, whereby the system is configured to
access the database to obtain an association of the items and the features as a static dataset;
load the static dataset and initial values of a dynamic dataset in the main memory of a computerized system; and
perform several computational cycles at the computerized system, wherein, in operation, each of the computational cycles comprises:
upon receiving an input of the user in respect of one or more of the features, updating the dynamic dataset according to the received input, whereby updated dynamic dataset values are stored in the main memory, the updated dynamic dataset values representing current valuations of the features of the items;
ordering the items according to the updated dynamic dataset values by performing an operation involving two operands accessed from the main memory, the two operands obtained from the static dataset and the updated dynamic dataset, respectively; and
based on the updated dynamic dataset, instructing to prompt the user to provide a further input in respect of one or more of the features associated with at least one of the items, and wherein
at least one of the cycles further comprises instructing to display an array of at least a subset of highest-ranked items of the ordered items together with features associated with each of the displayed items by virtue of the obtained association.

23. (canceled)

24. A computer program product for enabling a user to interact with a database associating items with features, the computer program product comprising a computer readable storage medium having program instructions embodied therewith, the program instructions executable by processing means of a computerized system, so as to cause the processing means to:
access the database to obtain an association of the items and the features as a static dataset;
load the static dataset and initial values of a dynamic dataset in the main memory of a computerized system; and
perform several computational cycles at the computerized system, wherein, in operation, each of the computational cycles comprises:
upon receiving an input of the user in respect of one or more of the features, updating the dynamic dataset according to the received input, whereby updated dynamic dataset values are stored in the main memory, the updated dynamic dataset values representing current valuations of the features of the items;
ordering the items according to the updated dynamic dataset values by performing an operation involving two operands accessed from the main memory, the two operands obtained from the static dataset and the updated dynamic dataset, respectively; and
based on the updated dynamic dataset, instructing to prompt the user to provide a further input in respect of one or more of the features associated with at least one of the items,
and wherein
at least one of the cycles further comprises instructing to display an array of at least a subset of highest-ranked items of the ordered items together with features associated with each of the displayed items by virtue of the obtained association.
